(19) United States
(12) Patent Application Publication
(10) Pub. No.: US 2006/0265425 A1
(43) Pub. Date: Nov. 23, 2006

(54) Media management for a computing device

(76) Inventors: Karl Christopher Raff II, Menlo Park, CA (US); Monty Boyer, Saratoga, CA (US); Keith Saft, San Francisco, CA (US); Matthew W. Crowley, Los Altos, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/132,357

(22) Filed: May 17, 2005

(51) Int. Cl. G06F 17/30

(52) U.S. Cl. 707/200

(57) ABSTRACT

A system and a method are disclosed for media file management, e.g., on a handheld computing device. The media file management system includes detecting presence of a storage media from a media device and automatically invoking software particularly configured to manipulate media files (or data) on the detected storage media. The media management system also includes detecting duplicate media files for transfer from a first location to a second location and in response to such detection of duplicates, stopping (or preventing) transfer of such duplicative media file. In addition, the media management system is configured to emulate on the handheld computing device a directory and file structure corresponding to particular media standards to allow existing media application software on a host computing system access the media files on the handheld computing device as an extension of the host computing system.

### CROSS REFERENCE TO RELATED APPLICATIONS

This application is related to U.S. patent application Ser. No. ______, filed on May 17, 2005, entitled “Optimal Viewing of Digital Images and Voice Annotation Transition for Slideshows” (Attorney Docket Number 24772-10363), the contents of which are hereby incorporated by reference.

### BACKGROUND OF THE INVENTION

1. Field of the Invention

The present invention generally relates to the field of media management, and more specifically, to media management on computing systems.

2. Description of the Related Art

Conventional handheld computing devices are known. Many conventional handheld computing devices include a media slot for plugging in a media storage card, e.g., a Compact Flash (CF) or Secure Digital (SD), or the like. The media storage card is used to capture data, particularly image data in the form of digital pictures (e.g., .jpg format) or short video (e.g., .avi format).

Typically, the media storage card includes data files. When the storage media card is inserted into the media slot of a handheld computing device, no action is taken with respect to it or the files located thereon. Rather, the user must explicitly go to a program launcher to select and execute an application that is appropriate for the data on the media storage card. Upon execution of the appropriate application, the user is able to access and manipulate those data files. For most novice users of conventional handheld computing devices, these extra steps are not intuitive. Moreover, these extra steps are often problematic because the user may not know which application to associate with which data file, particularly when data file formats differ. Requiring performance of these advanced steps frustrates the user's experience with the conventional handheld computing device.

Conventional approaches to address this problem are addressed on some laptop-type computing devices. Such devices require a predetermined mapping of specific files to particular applications. That is, conventional approaches must map each file to particular application based on a file type or on an individual file format. If a file type is unrecognized, the user is once again asked to select the file and application to run with it.

Other conventional approaches to address this problem attempt to use an intelligent external universal serial bus (USB) device that actively identifies itself to the computer. This configuration relies on file format type mappings. However, because this solution requires an intelligent external device, there is a significant relative increase in overall system costs. Moreover, this approach also requires cooperation on the part of both the media storage card and the external USB device for appropriate interactions between them, which itself becomes a limiting factor.

Another problem with media management on conventional handheld computing devices is that when a media card is selected to transfer files to a host system, e.g., a conventional handheld computing device, a laptop or desktop personal computer, previously copied duplicate files often are indiscriminately transferred between source media card and the destination host system. The new files at the destination are either overwritten or renamed to avoid duplicative file names, e.g., FIL00A to FIL00A_{—}1.

In each instance, conventional approaches to such processing resulted in greater time for file transfers. The operation became time consuming, leaving an unsatisfying and frustrating experience for the user because they had to wait for the transfer to complete, e.g., 40 seconds to over 1 minute for file transfers of 13 megabytes (MB) or more, before accessing the file. Further, such conventional solutions are also problematic for battery powered devices. Such time consuming operations draw increased battery power. The increased power draw also may heat up the device which may cause issues for heat sensitive components within the device. Further, the user often is left with a larger than necessary collection of files on the destination host system. Many of these files are duplicates and sometimes copies of the same files.

Yet another problem with media management on conventional handheld computing devices is the need for a user to learn new desktop or laptop applications for manipulation and transfer of data images on the conventional handheld computing device. Most users are familiar with a desktop or laptop application for manipulation of files on the specific media device, such as a particular model of digital camera. However, such solutions are not compatible with conventional handheld computing devices due to different communication and logic capabilities and specificity of design. Hence, conventional approaches use new applications on the desktop or laptop for interfacing with each specific model of conventional handheld computing device or other multimedia device, which are problematic for users because of the time and effort to learn yet another application in order to manipulate their digital images. Once again, this leaves user with an unsatisfying and frustrating experience.

From the above, there is a need for a media management system and process to that includes (1) detecting presence of a storage media from a media device and automatically invoking specific software to manipulate the data on the storage media, (2) effectively detecting duplicates of media files when copied from the media device and/or the storage media, and (3) allowing use of existing personal computing application software with a handheld computing device to manipulate files.

### SUMMARY OF THE INVENTION

An embodiment of the present invention includes a system (and a method) to detect presence of a media card for executing an application associated with a media file. In one embodiment, a system (or method) in accordance with the present invention receives notification of connection of the media card and reviews a directory and file structure on the media card. The system then executes a preemption program in response to the directory and file structure on the media card corresponding to a predetermined directory and file structure associated with a filetype of the media file.

In addition, in some embodiments the system can be configured to execute a default application or halts the operation in response to the directory and file structure on the media card not corresponding to the predetermined directory and file structure associated with the file type of the media file. Further, the system can be configured to copy the media file to a handheld computing device or a host personal computer in response to execution of the preemption program. Thereafter, the system may be configured to delete the media file from the media card in response to copying the media file.

Another embodiment of a system in accordance with the present invention includes a system (and a method) to prevent copying of duplicate media files in response to the media filed being selected for copying from a first location to a second location. In one embodiment, the system identifies (or determines) a directory and file location of a first media file and a directory and file location of a second media file. In response to the directory and file location of the first media file matching the directory and file location of the second media file, the system compares one ore more file attributes of the first media file with one or more file attributes of the second media file.

A file attribute comprises a predetermined unique representation of the data in each media file. For example, the file attribute can be a precalculated unique representation of the data contained in the file such as image compression data. In response to an exact match between file attribute of the first media file with the file attribute of the second media file, the system is configured to prevent copying of the first media file. It is noted that the media file may be, for example, a JPEG or MPEG media file, and the randomized characteristic is, for example, a compression size.

In another embodiment of the present invention, a system is configured to use an existing application hosted on a personal computer for manipulation of data files on a handheld computing device. In this embodiment, the system is configured such that a file system on the handheld computing device is structured for file format compatibility with a predetermined media type. With the file system configured, it is ready to store a media file. When a media file is stored in the file system, an existing application hosted on the host computer system can initiate a request to access the media file. Once accessed, the existing application hosted on the host computer system sends instructions that are received by the system to manipulate the accessed media file.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

Figures (FIGS.) 1a and 1b illustrate one embodiment of a handheld computing device in accordance with the present invention.

FIG. 2 illustrates one embodiment of a computing architecture of a handheld computing device in accordance with the present invention.

FIG. 3 illustrates one embodiment of a process for receiving notification of a media card connected with a handheld computing device to launch a preemption program in accordance with the present invention.

FIG. 4 illustrates one embodiment of a process for avoiding duplicative copying in accordance with the present invention.

FIGS. 5a and 5b illustrate one embodiment of a process for allowing a host computer image editing software to manipulate images on a handheld computing device in accordance with the present invention.

### DETAILED DESCRIPTION OF THE PREFERRED EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Example of Handheld Computing Device

Figures (FIGS.) 1a and 1b illustrate one embodiment of a handheld computing device 110 in accordance with the present invention. As illustrated in FIG. 1b, the handheld computing device 110 is configured to be of a form factor that is convenient to hold in a user's hand, for example, a personal digital assistant (PDA) or a smart phone form factor. For example, the handheld computing device 110 can have dimensions that range from 3 to 6 inches by 2 to 5 inches by 0.25 to 0.85 inches and weigh between 2 and 10 ounces.

Referring to FIG. 1a, the handheld computing device 110 includes a screen (or display) 115, a screen navigation interface 120, an expansion port (or slot) 125, a stylus 130, a microphone 135, and one or more control buttons, e.g., voice recorder button, screen rotation button, etc., 140a, b (generally 140). The screen is, for example, a 320×480 transflective TFT color display that includes touch screen support. The expansion slot 125 is configured to receive and support expansion cards (or media cards) that include memory cards such as CompactFlash™ cards, SD cards, XD cards, Memory Sticks™, MultiMediaCard™, SDIO, and the like. Further, the screen navigation interface 120, the stylus 130, the microphone 135, and the one or more control buttons 140 are conventional, although various functions can be applied to them.

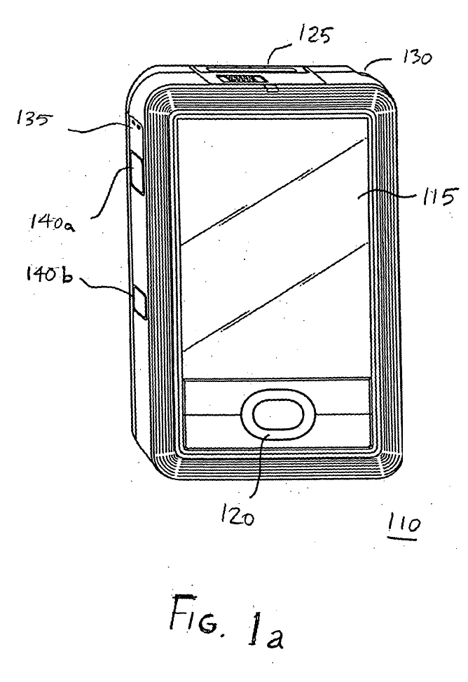

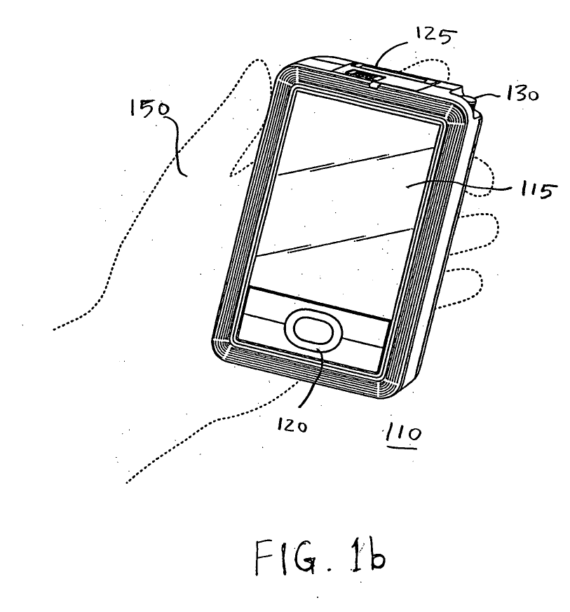

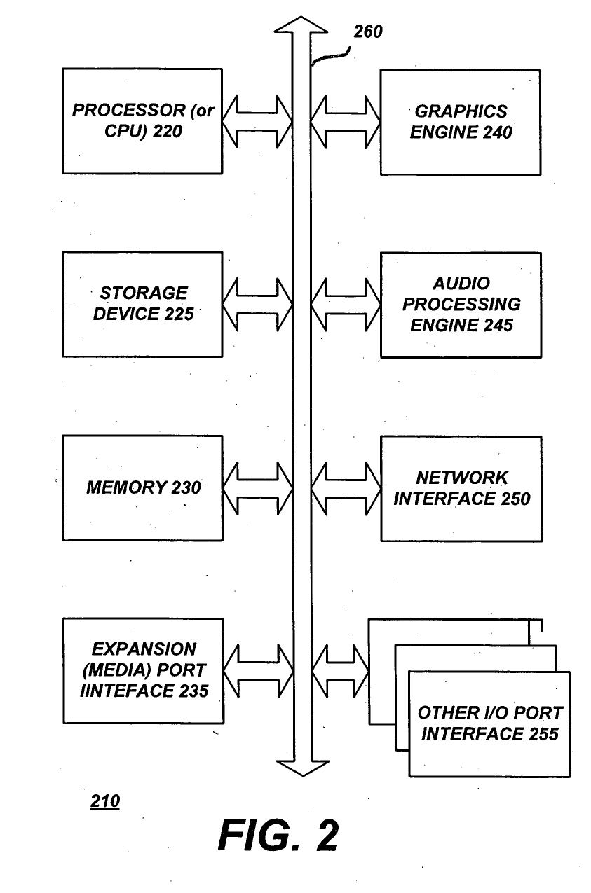

Turning to FIG. 2, illustrated is one embodiment of a computing architecture 210 of the handheld computing device 110 in accordance with the present invention. The architecture 210 includes a processor (or CPU) 220, a storage device 225, a memory 230, an expansion (or media) port interface 235, an optional graphics engine 240, an audio processing engine 245, a network interface 250, and one or more other input/output (I/O) port interfaces 255. Each of the components of the computing architecture may communicatively couple through a data bus 260.

The processor 220 is a conventional processor or controller such as an Intel® XScale™ processor. The storage device 225 is a conventional long term storage device, for example, a hard drive (e.g., magnetic hard drive) or a flash memory drive. The memory 230 is a conventional computing memory such as a random access memory (RAM). The expansion port interface 235 is configured to interface with a media card such as the ones previously described. The optional graphics engine 240 may include hardware, e.g., graphics chip, in addition to software to enhance graphics for display on the screen 115.

The audio processing engine 245 is configured for audio related processing such as recording and playback. The audio processing engine 245 includes appropriate hardware (e.g., microphone, speaker, and/or ports (or jacks)) and software (e.g., sound controls) to achieve such functionality. The network interface 250 is configured for network connections to a wide range of networks and includes appropriate hardware and software to communicatively couple to such networks. Examples of networks that can be configured to function with the handheld computing device 110 include personal area networks (e.g., Bluetooth), wireless networks (e.g., IEEE 802.11), and telecommunications networks (e.g., cellular or data). The one or more other I/O ports 255 include interfaces for connections such as universal serial bus (USB), IEEE 1394 (e.g., FireWire), and the like.

In addition, it is noted that the handheld computing device 110 is configured to use conventional operating systems such as Palm OS® from PalmSource™, Inc. or Windows CE from Microsoft® Corporation. It is noted that the device can also be configured for use with other operating systems, for example, Linux-based operating systems.

Detecting Presence of a Media Card

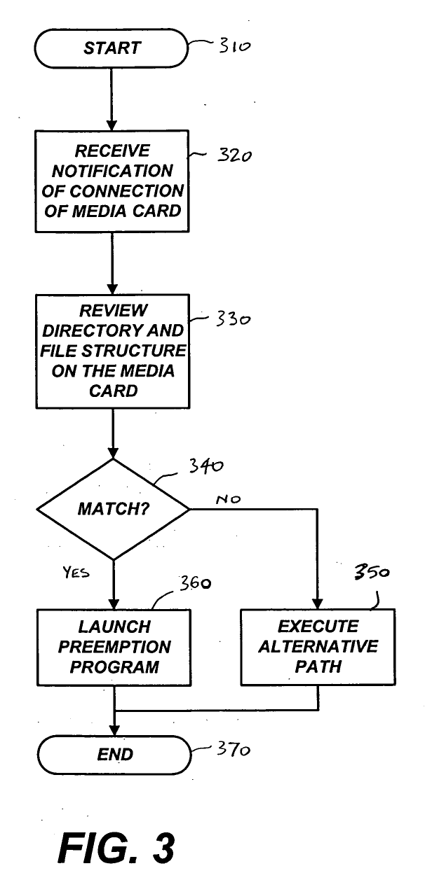

FIG. 3 illustrates one embodiment of a process for receiving notification of a media card connected with the handheld computing device 110 to launch a preemption program in accordance with the present invention. The process starts 310 and receives 320 notification that a media card is connected (or mounted) through the expansion port 125 (and expansion port interface 235) of the handheld computing device 110. It is noted that in alternative embodiments, the media card can be any external storage device. In addition, any media card (or external storage device) may be connected with the handheld computing device through a wireless connection, e.g., Bluetooth, which provides a notification signal.

The process reviews 330 the directory and file structure on the media card. In one embodiment, the process seeks to identify a predefined directory and file structure for certain types of information or data capture. For example, for digital images (or photos) captured by a digital camera the process determines whether the directory and file structure conforms to the Design Rule for Camera File (DCF) specification published by the Japan Electronics and Information Technology Association, the relevant content of which are herein incorporated by reference.

If the process determines 340 that there is not a match between the directory and file structure on the media card with the predefined directory and file structure that is used for comparison (e.g., the DCF specification), the process executes 350 an alternative path such as prompting the user with a message on the screen 115 to obtain instructions on what action to take (e.g., “Open file”) or notifying the user with a message on the screen 115 that the media card is connected to the device (e.g., “Media card is inserted). The process then ends 370.

However, if the process determines 340 that there is a match between the directory and file structure on the media card with the predefined directory and file structure that is used for comparison (e.g., the DCF specification), the process launches (or executes) 360 a preemption program. The preemption program is configured to preempt conventional messages, such as “Open file?” or “Media card is inserted,” with a program that executes a particular action. The preemption program directly corresponds to the particular file type on the media card. For example, in the context of digital images that are stored in DCF compliant directory and file structure, the preemption program is configured to execute a program that inquires whether the user wants to unload the contents on the card (e.g., copy them to the handheld computing device 110 or a host personal computer), view them, or cancel operation of the program.

The preemption program can be configured to also automatically default to one of the options. In addition, the preemption program can be configured to be predictive in terms on remembering a predetermined number of consecutive actions by a user and thereafter automatically launching that function (in essence, predicting that such action is what the user would perform yet again). The preemption program can be configured to allow other actions, for example, enter into a photo editing mode or combine actions such as copy to the storage device 225 on the handheld computing device 110 and erase the contents from the media card after copying. The underlying operations are highly customizable once the directory and file structure is identified and the system is able to associate actions appropriate for the data that would be stored in such directory and file structure formats.

In one embodiment, the process described in FIG. 3 is configured for operation as software (or a computer-implemented program product). The software can be stored as instructions in a memory 230 or on a storage device (e.g., hard disk, Compact Disc, DVD, flash drive, etc.) 225 and can be executable by the processor 220. The instructions (e.g., steps) of the process may also be configured as one or more modules configured to perform the function or functions described.

Detecting Duplicates During Copying

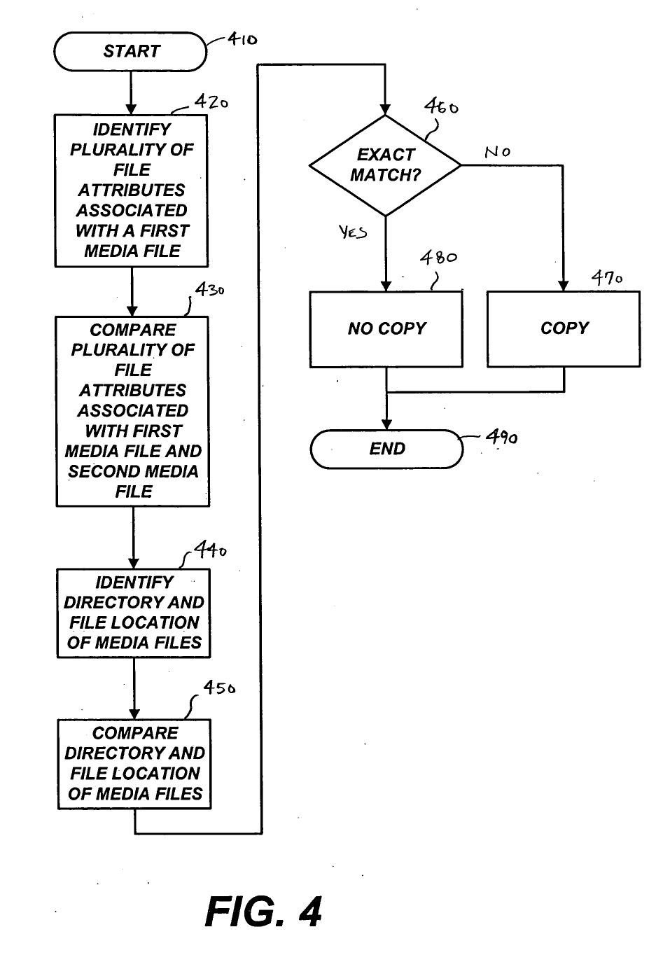

Among the actions described above, copying files from one device, e.g., a media card, to a second device, e.g., a storage device 225 on the handheld computing device 110, can be relatively time consuming and a drain on system resources such as power and storage space. FIG. 4 illustrates one embodiment of process for avoiding duplicative copying in accordance with the present invention, which reduces latency with respect to interacting with the file as well as reduces power draw.

For ease of explanation and understanding, the process in FIG. 4 will be described in the context of a first media file on a media card, which is a source location. The first media file can be, for example, a digital image that has been captured by a digital camera and stored as described in FIG. 3. The first media file is to be copied to a destination location, e.g., the storage device 225 of the handheld computing device 110.

The process starts 410 and identifies 420 one or more file attributes that are associated with the first media file. The file attributes include the file name, as well as metadata (or flag) type information such as image resolution, thumbnail information, camera model/brand, captions, time, compression size, and the like. The process then determines whether a similar file exists on the destination location. Specifically, the process compares 430 the one or more file attributes of the first media file with one or more file attributes of a second media file, which is already on the destination location.

Next, the process identifies 440 the directory and location of the media files and compares 450 the directory and location of the first media file and the second media file. Note that for digital images from cameras that are DCF compliant, the directory and file name of the image will be in a format that is NNNAAAAA, where N is a numeric character and A is an alpha character, which provides appropriate information on whether both media files being compared are from the same directory and file location.

It is noted that in an alternative embodiment, the process is configured so that steps 440 and 450 occur before steps 420 and 430. In particular, for each filename identified 440 in the source (e.g., a media storage card), the process checks (or does a comparison 450) for a matching filename in the same location at the destination (e.g., the storage device 225 of the handheld computing device 110). If there is a match, the process then identifies 420 and checks (or does a comparison 430) for one or more attributes of the files. It is noted that for file attributes, the process can be configured to use data-dependent, but statistically unique, file attributes. That is, the process can be configured to look for one or more file attributes that are a predetermined unique representation of the data contained in the image file. For example, the process can identify a pre-calculated unique representation of the data such as compression size of the image files being checked (or compared).

Once the directory and location of the files is identified and checked and the one or more file attributes are identified and checked, the process determines 460 if there is an exact match between the two media files. If there is not an exact match, the process copies 470 the first media file to the destination location. If there is an exact match, the process does not copy 480 the first media file and moves on to analyze whether the next media file on the source media card should be copied to the destination location. The process ends 490 when all the appropriate files on the source, e.g., media card, are copied or not copied to the destination, e.g., the storage medium 225.

An advantage of the process disclosed is operational speed. For example, comparing one or more file attributes increases system performance speed because there is not need to examine actual image data. Moreover, the process allows for increased operational flexibility. For example, because the process can be configured to use a predetermined unique representation of the data in each image file, the process does not need to perform a complete data comparison. Rather, the process can be configured to truncate immediately upon identifying a difference between the compared files. Alternatively, the process can be configured to truncate after checking some predetermined percentage of the files where it is statistically likely that differences between the files, if any, can be identified. For example, the process can be structured to compare a randomly selected portion (e.g., 5%) in a random position (e.g., 40% from a start point) in a body of each media file's data.

Thus, the process flexibility includes use of a random sampling that statistically represents individuality of a file's whole contents, while also taking advantage of aspects such as compression algorithm characteristics. Such a configuration enhances performance for copying files from the source to destination, for example, increasing the speed and reducing the time for copying files from a source to destination.

For further descriptions relating to the process disclosed in accordance with the present invention, consider the following example scenarios. In a first example scenario, a user takes a photo (digital image) with his digital camera and transfers it to the handheld computing device 110 by moving the media card, e.g., CompactFlash™ card, from the digital camera to the handheld computing device 110. Thereafter, the user transfers it to a personal computer using camera software installed on the personal computer.

In this first example scenario, a process starts with the media card on the digital camera, the handheld computing device 110, and the personal computer all being initially clear of digital images. Next, the user takes a single photo with the digital camera. The user removes the media card from camera and inserts it into the expansion slot 125 on the handheld computing device 110. The user (or the system) activates a program to transfer the digital image corresponding to the photo to the storage device 225 in the handheld computing device 110 and copies the digital image onto the storage device 225.

Note that different batches of digital images can be merged in such a way so that duplicates are not created in the handheld computing device 110. Further, the experience of transferring digital images through the handheld computing device 110 to the personal computer is identical to transferring directly from the digital camera to the personal computer. In addition, digital images from different digital cameras may need to be merged. If two digital cameras generate the same file names both need to be backed up. In general, the DCF specification for directory structure is maintained. In particular, all files (JPEG, MPEG, WAV, AVI, etc.) under the \DCIM directory are copied including the directories and the files contained within them.

If duplicate file names are encountered in the destination directory of the handheld computing device 110, then all the media card files with the same name (for example both IMG_{—}1698.JPG and IMG_{—}1698.WAV) are post-pended with a letter (e.g., IMG_{—}1698b.*). Files with same name but different extensions coming from a digital camera need to match otherwise things like voice annotations for digital images will not match the correct photo. Note that different camera vendors may create folders with different names under the \DCIM directory. In general, they are named NNNAAAAA where NNN is a three-digit number and AAAAA can be the camera manufacturer's name (e.g., Canon) or the camera model or anything else (alphanumeric).

Once the digital images are transferred, the user now has the option to clear the media card by selecting such an option in the copying software of the handheld computing device 110 (or alternatively, a hardware or software button with such functionality). The user can remove the media card from the handheld computing device 110 and insert back into the digital camera for further use. The user can also connect the handheld computing device 110 to the personal computer via a bus, e.g., USB.

In a second example scenario, the user takes a photo with his digital camera, transfers it to the handheld computing device 110 by moving the media card from the digital camera to expansion slot 125 of the handheld computing device 110. The copying program on the handheld computing device 110 is executed to transfer the digital image to the personal computer. In this scenario, the images are deleted from the media card once they are transferred to the storage device 225 of the handheld computing device 110. The images can then be transferred to the personal computer from the storage device 225 of the handheld computing device 110. The process can be configured so as the images are deleted from the storage device 225 of the handheld computing device 110 once they are transferred to the personal computer. The user can then take another photo and transfer it to the handheld computing device 110 and then to the personal computer in the same way as in the first example scenario.

In the third example scenario, the user takes a photo with the digital camera and transfers it to the handheld computing device 10 by moving the media card from the digital camera to the expansion slot 125 of the handheld computing device 110. The user then transfers the digital image to the personal computer from the handheld computing device 110. In this scenario, the user does not erase the original digital image (recharge the media card) on the digital camera or on the handheld computing device 110 when they are transferred onto, respectively, the handheld computing device 110 and the personal computer. The user then takes another photo and transfers it to the handheld computing device 110 and then to the personal computer in the same way as in first scenario.

Note that the handheld computing device 110 can be configured to detect new images on the media card by process of elimination. In particular, old, previously copied images on the media card are matched with their counterparts on the storage device 225 of the handheld computing device 110, and if matched, they are not copied. The remaining images on the media card are copied to the storage device 225 of the handheld computing device 110.

In the fourth example scenario, the user has placed files on the media card directly by copying and pasting using the personal computer based software while the media card was connected directly to the personal computer and mounted like a disk drive. In this scenario, the user takes a photo with the digital camera and transfers it to the handheld computing device 110 and then to the personal computer. In this example scenario, the files not in the DCIM folder structure are not affected, although files in the DCIM structure may need to be transferred.

It is noted that the process collects and maintains sufficient attribute data to allow for thoroughness in determining whether a particular file is a duplicate. For example, with digital images the process maintains compression size attribute information. Compression sizes (e.g., for run length compression algorithms) change for each digital image (picture) taken by a camera, even when the camera takes a picture of the same view consecutively. Hence, such information provides a unique identifier that is specific to a file's content and can be used as a final arbiter to determine whether there is an exact match between two digital image files without actually having to examine the file's contents themselves. Likewise, other unique identifiers may be made available to provide final arbitration as to whether a duplicate is present.

In one embodiment, the process described in FIG. 4 is configured for operation as software (or a computer-implemented program product). The software can be stored as instructions in a memory 230 or on a storage device (e.g., hard disk, Compact Disc, DVD, flash drive, etc.) 225 and can be executable by the processor 220. The instructions (e.g., steps) of the process may also be configured as one or more modules configured to perform the function or functions described.

The system and process described offers a much richer configuration for determining whether or not to copy files from a source to a destination than, for example, a file comparison based system. Further, an advantage of the system and process described for preventing copying of previously copied files is that it greatly increases resource efficiencies by drawing less power for such operations while significantly reducing the time for performing such functions because time and resources are not expended for copying files that were previously copied over to the destination. Additionally, extra storage space is not consumed by duplicate files.

Use of Existing Camera Software for Data Manipulation

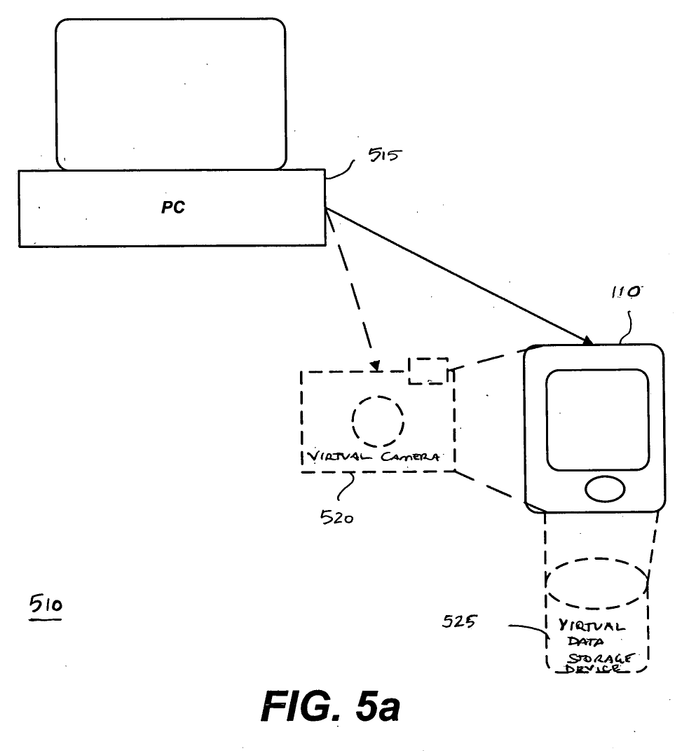

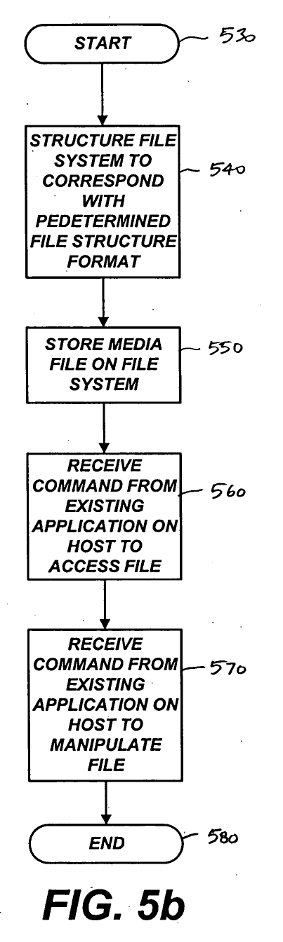

Once the media files are transferred from the media card to the handheld computing device 110, a user may want to further manipulate those media files without needing to learn a new software program for this task. FIGS. 5a and 5b illustrate one embodiment of a process for allowing image editing software (or camera software program) hosted on a personal computer to manipulate images on a handheld computing device in accordance with the present invention.

FIG. 5a illustrates an environment 510 for use in accordance with an embodiment of the process described herein. The environment 510 includes the handheld computing device 110 and a personal computer 515. The environment, as will be described, also includes a virtualized digital camera 520 and virtualized data storage device 525. The personal computer 515 is a conventional personal computer (e.g., an Intel Pentium® or Celeron® processor and Microsoft Windows™ operating system), which includes camera image editing software. The image editing software, often bundled with a purchase of a digital camera 520, is used to retrieve, manipulate, and view images that are on the digital camera 520.

The process in accordance with the present invention is further described in FIG. 5b, with reference also made to FIG. 5a. Overall, the process starts 530 and includes a file system on the handheld computing device 110 structured 540 to correspond with a predetermined format for a file structure. For example, the storage device 225 in the handheld computing device 110 can be structured 525 (FIG. 5a) to emulate the directory and file structure format for a digital camera as is defined in the DCF specification. The emulation of directory and file structure format for the digital structure is shown as the virtualized digital camera 520 in FIG. 5a. Thereafter, a media file (e.g., a photo) stored 550 on the structured file system (shown via the virtualized data storage device 525) in the storage device 225 of the handheld computing device 110.

When a user of the personal computer 515 seeks to access the media file in the handheld computing device 110, the handheld computing device 110 receives 560 a command from the existing image editing software on the personal computer 515 to get access to the media file. Because of the structured file system 525 of the storage device 225 of the handheld computing device, the personal computer 515 image editing software behaves as if it is accessing a digital camera 520 rather than the handheld computing device 10 it is actually accessing. The handheld computing device 110 thereafter receives 570 commands from the existing image editing software on the personal computer 525 for manipulating (e.g., copying, pasting, cutting, shading, annotating, or otherwise editing) the media file before the process ultimately ends 580.

In one embodiment, the processes described with respect to FIGS. 5a and 5b are configured for operation as software (or a computer-implemented program product). The software can be stored as instructions in a memory 230 or on a storage device (e.g., hard disk, Compact Disc, DVD, flash drive, etc.) 225 and can be executable by the processor 220. The instructions (e.g., steps) of the process may also be configured as one or more modules configured to perform the function or functions described.

Advantages of the present invention include the ability to use existing image editing software on a personal computer, e.g., 515, to manipulate images on a device such as a handheld computing device e.g., 110. In particular, the system is configured such that the structured file system on the handheld computing device is configured to be like one of a predefined format, e.g., the DCF specification. Thus, the image editing software on the personal computer can view the handheld computing device as a known device, e.g., a digital camera. Alternatively, the personal computer can consider the handheld computing device to be a separately mounted disk drive with which it can interact.

It is noted that although the disclosure herein makes references in some embodiments to interaction between a personal computer and handheld computing device, the principles disclosed herein are applicable to any configuration in which two computing devices are communicatively coupled. For example, in some embodiments there may be communications between a first computing device and a second computing device wherein the first device can be any computing type device (e.g., a server computer system, a desktop computer, a laptop computer, a personal digital assistant, a gaming device, a smart phone, etc.) or a portable computing system) and the second device can be any computing device (e.g., also a server computer system, a desktop computer, a laptop computer, a personal digital assistant, a gaming device, a smart phone, etc), of which one device may be a host and the other a client or the devices may be peers (e.g., peer to peer connection).

Upon reading this disclosure, those of skill in the art will appreciate still additional alternative structural and functional designs for a system and a process for media management on a handheld computing device through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A method for detecting presence of a media card for executing an application associated with a media file, the method comprising:
receiving notification of connection of the media card;
reviewing a directory and file structure on the media card; and
executing a preemption program in response to the directory and file structure on the media card corresponding to a predetermined directory and file structure associated with a filetype of the media file.

2. The method of claim 1, further comprising executing a default application or halting the process the in response to the directory and file structure on the media card not corresponding to the predetermined directory and file structure associated with the file type of the media file.

3. The method of claim 1, further comprising copying the media file to a handheld computing device or a host personal computer in response to execution of the preemption program.

4. The method of claim 3, further comprising deleting the media file from the media card in response to copying the media file.

5. The method of claim 3, further comprising allowing the media file to be viewable on the handheld computing device in response to copying the media file.

6. The method of claim 1, wherein the directory and file structure on the media card corresponds to the design rules for camera file system (DCF) specification.

7. The method of claim 1, wherein steps of the method are stored as instructions on a computer readable medium for execution by a processor.

8. A method for preventing copying of duplicate media files in response to a copy operating from a first location to a second location, the method comprising:
identifying a directory and file location of a first media file;
identifying a directory and file location of a second media file;
in response to the directory and file location of the first media file matching the directory and file location of the second media file, comparing a file attribute of the first media file with a file attribute of the second media file, the file attributes comprising a predetermined unique representation of the data in each media file; and
in response to an exact match between file attribute of the first media file with the file attribute of the second media file, preventing copying of the first media file.

9. The method of claim 8, wherein the first media file and the second media file comprise a JPEG filetype.

10. The method of claim 8, wherein the first media file and the second media file comprise a MPEG filetype.

11. The method of claim 8, wherein the predetermined unique representation of the data of each media file comprises a file compression size.

12. The method of claim 8, wherein directory and file location corresponds to the design rules for camera file system (DCF) specification.

13. The method of claim 8, wherein comparing the file attribute of the first media file with the file attribute of the second media file comprises comparing a plurality of file attributes of each media file.

14. The method of claim 8, wherein steps of the method are stored as instructions on a computer readable medium for execution by a processor.

15. A method for using an existing application hosted on a host computer system for manipulation of data files on a handheld computing device, the method comprising:
structuring a file system on the handheld computing device to mimic a predetermined media file format;
storing a media file in the file system;
receiving, from the existing application hosted on the host computer system, a request to access the media file; and
receiving, from the existing application hosted on the host computer system, instructions to manipulate the accessed media file.

16. The method of claim 15, wherein the predetermined media file format corresponds to the design rules for camera file system (DCF) specification.

17. The method of claim 15, wherein the existing application corresponds to a photo editing application.

18. The method of claim 15, wherein the media file comprises a JPEG file.

19. The method of claim 15, wherein the media file comprises a MPEG file.

20. The method of claim 15, wherein steps of the method are stored as instructions on a computer readable medium for execution by a processor
